(19) United States
(12) Patent Application Publication
(10) Pub. No.: US 2026/0233375 A1
(43) Pub. Date: Aug. 13, 2026

(54) POWER TOOL

(71) Applicant: Makita Corporation, Anjo-shi (JP)

(72) Inventor: Akira MIZUTANI, Aichi (JP)

(73) Assignee: Makita Corporation, Anjo-shi (JP)

(21) Appl. No.: 19/531,034

(22) Filed: Feb. 5, 2026

(30) Foreign Application Priority Data
Feb. 12, 2025 (JP) 2025-020796

(51) Int. Cl. B25F 5/02; B23D 51/10; B23D 61/00; B25F 3/00; H01H 13/14

(52) U.S. Cl. CPC B25F 5/02; B23D 51/10; B23D 61/006; B25F 3/00; H01H 13/14

(57) ABSTRACT

A power tool includes a motor, a spindle, an inner housing housing the motor, an outer housing, and at least one press button type switch. The spindle is configured to use power from the motor to drive a tip tool to oscillate around a drive axis defining an up-down direction of the power tool. The inner housing extends in a front-rear direction of the power tool orthogonal to the drive axis. The outer housing houses the inner housing. The at least one press button type switch switches the motor on and off in accordance with a manual operation by a user.

### CROSS-REFERENCE

The present application claims priority to Japanese patent application serial number 2025- 20796 filed on February 12, 2025, the contents of which are fully incorporated herein by reference.

### TECHNICAL FIELD

The present disclosure relates to a power tool.

### BACKGROUND

A power tool is known that includes an operation portion for switching a motor on and off. For example, in US 20060032650 A1, a power tool is disclosed in which operation portions are respectively disposed in a plurality of regions separated from each other on an outer surface of a housing. In this power tool, in a state in which the power tool is held, a configuration is adopted in which activation of the motor is allowed by operating the operation portion disposed in one of the regions simultaneously with the operation portion disposed in another of the regions.

### SUMMARY

In the known technology, the plurality of operation portions are arranged to be separated from each other. Thus, inside the housing, the arrangement of components of an electrical system, such as lead wires and the like that electrically connect the operation portions and the motor, becomes complicated, and there is a possibility that the housing may become larger. Further, in the power tool, in the known technology, it cannot be said that sufficient consideration has been given to an anti-vibration structure of the power tool with respect to vibrations that occur in accordance with the driving of the motor or a tip tool.

Thus, in the power tool, a technology is desired in which an operation portion is appropriately arranged and an increase in size of the power tool is suppressed, while providing an anti-vibration structure.

One non-limiting object of the present disclosure is to suppress, in a power tool, an increase in size of the power tool resulting from a switch configuration, while providing an anti-vibration capability

According to a non-limiting aspect of the present disclosure, a power tool is provided. The power tool includes a motor, a spindle, an inner housing housing the motor, an outer housing, and at least one press button type switch. The spindle is configured to use power from the motor to drive a tip tool to oscillate around a drive axis defining an up-down direction of the power tool. The inner housing extends in a front-rear direction of the power tool orthogonal to the drive axis. The outer housing houses the inner housing. The at least one press button type switch is configured to switch the motor on and off in accordance with a manual operation by a user.

The power tool according to the present aspect includes an anti-vibration housing having a two-layer structure including an inner housing and an outer housing that houses the inner housing, and includes a press button type switch. By using the press button type switch as an operation portion that switches a motor on and off, compared to a configuration in which operation portions are provided at a plurality of locations, a region in which the operation portion and the switch are disposed can be made smaller. Further, it is possible to omit a member, such as a switch lever, that joins the switch for switching the motor on and off to the operation portion, and a number of components inside the housing can be reduced, compared to an operation portion using a switch knob. Thus, it is possible to provide the power tool that is suppressed from becoming larger due to a switch configuration, while providing a high anti-vibration capability.

According to another non-limiting aspect of the present disclosure, a power tool is provided. The power tool includes a motor, a spindle, an inner housing housing the motor, an outer housing, an operation portion, a switch, and a lead wire. The spindle is configured to use power from the motor to drive a tip tool to oscillate around a drive axis defining an up-down direction of the power tool. The inner housing extends in a front-rear direction of the power tool orthogonal to the drive axis. The outer housing houses at least a part of the inner housing. The operation portion is configured to be operable by a user. The switch is configured to switch the motor on and off in accordance with operation of the operation portion. The lead wire electrically connects a controller configured to control driving of the motor to the switch. The lead wire is disposed between the inner housing and the outer housing.

According to the power tool according to the present aspect, by utilizing a space formed by an anti-vibration housing having a two-layer structure including an inner housing and an outer housing that houses the inner housing, the lead wire can be efficiently disposed inside the housing. Thus, it is possible to provide the power tool that is suppressed from becoming larger due to a switch configuration, while providing a high anti-vibration capability.

### BRIEF DESCRIPTION OF THE DRAWINGS

FIG. 1 is a perspective view showing an external configuration of an oscillating tool according to a first embodiment.

FIG. 2 is a cross-sectional view showing an internal configuration of the oscillating tool.

FIG. 3 is a cross-sectional view at a position III-III shown in FIG. 2.

FIG. 4 is a perspective view showing an external configuration of an inner housing.

FIG. 5 is a cross-sectional view showing a configuration of a drive mechanism.

FIG. 6 is a cross-sectional view at a position VI-VI shown in FIG. 5.

FIG. 7 is an explanatory diagram showing a configuration of an elastic coupling portion when the oscillating tool is seen from the side.

FIG. 8 is an explanatory diagram showing the configuration of the elastic coupling portion when the oscillating tool is seen from above.

FIG. 9 is a cross-sectional view at a position IX-IX shown in FIG. 7 and FIG. 8.

FIG. 10 is an explanatory diagram showing an arrangement configuration of a switch knob and switch.

FIG. 11 is a cross-sectional view showing an internal configuration of the oscillating tool according to a second embodiment.

FIG. 12 is a cross-sectional view showing an internal configuration of the oscillating tool according to a third embodiment.

FIG. 13 is an explanatory diagram showing an external configuration of an oscillating tool according to a fourth embodiment.

FIG. 14 is an explanatory diagram showing an external configuration of a tact switch.

FIG. 15 is a cross-sectional view at a position XV-XV shown in FIG. 14.

FIG. 16 is a cross-sectional view showing an internal configuration of the oscillating tool according to the fourth embodiment.

### DETAILED DESCRIPTION OF THE EMBODIMENTS

Hereinafter, representative and non-limiting specific examples of the present invention will be described in detail with reference to the drawings. This detailed description is simply intended to show, to a person skilled in the art, details for embodying a preferable example of the present invention, and is not intended to limit the scope of the present disclosure. Further, additional features and the disclosure disclosed below can be used separately or together with other features and disclosures, in order to provide a further improved device, and a manufacturing method and a usage method thereof.

Further, combinations of features and processes disclosed in the following detailed description are not essential, in broad terms, when embodying the present disclosure, and, in particular, are given for describing representative specific examples of the present invention. Furthermore, when presenting additional and effective embodiments of the present disclosure, various features of representative specific examples described above and below, and various features described in independent and dependent claims need not necessarily be combined as in the specific examples given here, or in a given order.

All features listed in the present specification and/or in the scope of the claims are intended to be disclosed separately, and independently of each other, as limitations to the disclosure at the time of filing and to the claimed specific items, separately to the configuration of features listed in the embodiments and/or in the scope of the claims. Furthermore, description relating to all numerical ranges and groups or collections are treated as intending to disclose intermediate configurations related thereto, as limitations to the disclosure at the time of filing and to the claimed specific items.

In a non-limiting embodiment of the present disclosure, when one end portion of the spindle to which the tip tool is attached is defined as a lower side of the power tool in the up-down direction, and the other side is defined as an upper side, the at least one press button type switch may be disposed further to the upper side than a center axis of the inner housing.

According to this embodiment, a user can easily see the press button type switch from above and can easily operate the press button type switch.

In addition to the above-described embodiment, or in place of the above-described embodiment, when one end portion of the inner housing in which the spindle is housed is defined as a front side in the front-rear direction, and the opposite side is defined as a rear side, the at least one press button type switch may be disposed further to the front side than a center point of the inner housing in the front-rear direction.

According to this embodiment, the user can easily see the press button type switch even while holding the power tool, and can easily operate the press button type switch.

In addition to the above-described embodiment, or in place of the above-described embodiment, the inner housing may include a motor housing and a front housing. The motor housing may house the motor. The front housing may be connected to a front end of the motor housing, and may house the spindle. The at least one press button type switch may be disposed at at least one of an outer side of the motor housing or an outer side of the front housing, in a radial direction around a center axis of the inner housing.

According to this embodiment, compared to a case in which the press button type switch is disposed at the outer side of a member disposed further to the rear than the front housing or the motor housing, a grip region of the power tool can be formed to be wider in the front-rear direction, and portability of the power tool can be improved.

In addition to the above-described embodiment, or in place of the above-described embodiment, when one end portion of the inner housing in which the spindle is housed is defined as a front side in the front-rear direction, and the opposite side is defined as a rear side, the at least one press button type switch may be disposed further to the rear side than the front housing.

According to this embodiment, compared to a case in which the press button type switch is disposed at the front housing, it is possible to dispose the operation portion at a position separated from a workpiece and a tip tool. Thus, operability of the press button type switch can be improved.

In addition to the above-described embodiment, or in place of the above-described embodiment, the power tool may further include a lead wire. The lead wire may electrically connect the at least one press button type switch to a controller configured to control driving of the motor. The lead wire may be disposed between the inner housing and the outer housing.

According to this embodiment, by utilizing a space formed by an anti-vibration housing having a two-layer structure including the inner housing and the outer housing, the lead wire can be efficiently disposed inside the housing. Thus, it is possible to provide the power tool that is suppressed from becoming larger due to a switch configuration, while providing a high anti-vibration capability.

In addition to the above-described embodiment, or in place of the above-described embodiment, the at least one press button type switch may include a first switch and a second switch different from the first switch.

According to this embodiment, by providing the two switches, the user can easily cause the power tool to execute a plurality of functions.

In addition to the above-described embodiment, or in place of the above-described embodiment, the motor may include a motor shaft configured to rotate around a motor rotation axis. The motor rotation axis may be orthogonal to the drive axis.

According to this embodiment, compared to a power tool in which the motor is housed such that the motor rotation axis is parallel to the drive axis, the front housing can be downsized. Thus, a front end portion of the power tool can be downsized.

In addition to the above-described embodiment, or in place of the above-described embodiment, the power tool may further include a switch unit including the operation portion and the switch.

According to this embodiment, components of an operation system including the operation portion and the switch can be concentrated in the switch unit. Thus, compared to a case in which the operation portion and the switch are disposed in a plurality of locations separated from each other, a number of components inside the housing can be reduced, and the power tool can be downsized.

In addition to the above-described embodiment, or in place of the above-described embodiment, when one end portion of the spindle to which the tip tool is attached is defined as a lower side of the power tool in the up-down direction, and the other side is defined as an upper side, the switch unit may be disposed further to the upper side than a center axis of the inner housing.

According to this embodiment, the user can easily see the switch unit from above, and can easily operate the operation portion.

In addition to the above-described embodiment, or in place of the above-described embodiment, when one end portion of the inner housing in which the spindle is housed is defined as a front side in the front-rear direction, and the opposite side is defined as a rear side, the switch unit may be disposed further to the front side than a center point of the inner housing in the front-rear direction.

According to this embodiment, the user can easily see the switch unit even while holding the power tool, and can easily operate the operation portion.

In addition to the above-described embodiment, or in place of the above-described embodiment, the inner housing may include a motor housing and a front housing. The motor housing may house the motor. The front housing may be connected to a front end of the motor housing, and may house the spindle. The switch unit may be disposed at at least one of an outer side of the motor housing or an outer side of the front housing, in a radial direction around a center axis of the inner housing.

According to this embodiment, compared to a case in which the switch unit is disposed at the outer side of a member disposed further to the rear than the front housing or the motor housing, the grip region of the power tool can be formed to be wider in the front-rear direction, and the portability of the power tool can be improved.

In addition to the above-described embodiment, or in place of the above-described embodiment, the power tool may further include a switch unit housing the operation portion and the switch.

According to this embodiment, the operation portion and the switch can be concentrated in one location as the switch unit. Thus, compared to a case in which the operation portion and the switch are disposed in a plurality of locations, the number of components inside the housing can be reduced, and the housing can be downsized.

In addition to the above-described embodiment, or in place of the above-described embodiment, when one end portion of the spindle to which the tip tool is attached is defined as a lower side of the power tool in the up-down direction, and the other side is defined as an upper side, the switch unit may be disposed further to the upper side than a center axis of the inner housing.

According to this embodiment, the user can easily see the switch unit from above, and can easily operate the operation portion.

In addition to the above-described embodiment, or in place of the above-described embodiment, when one end portion of the inner housing in which the spindle is housed is defined as a front side in the front-rear direction, and the opposite side is defined as a rear side, the switch unit may be disposed further to the front side than a center point of the inner housing in the front-rear direction.

According to this embodiment, the user can easily see the switch unit even while holding the power tool, and can easily operate the operation portion.

In addition to the above-described embodiment, or in place of the above-described embodiment, the inner housing may include a motor housing and a front housing. The motor housing may house the motor. The front housing may be connected to a front end of the motor housing, and may house the spindle. The switch unit may be disposed at at least one of an outer side of the motor housing or an outer side of the front housing, in a radial direction around a center axis of the inner housing.

According to this embodiment, compared to a case in which the switch unit is disposed at the outer side of a member disposed further to the rear than the front housing or the motor housing, the grip region of the power tool can be formed to be wider in the front-rear direction, and the portability of the power tool can be improved.

In addition to the above-described embodiment, or in place of the above-described embodiment, when one end portion of the inner housing in which the spindle is housed is defined as a front side in the front-rear direction, and the opposite side is defined as a rear side, the switch unit may be disposed further to the rear side than the front housing.

According to this embodiment, compared to a case in which the press button type switch is disposed at the front housing, it is possible to dispose the operation portion at a position separated from the workpiece and the tip tool. Thus, operability of the press button type switch can be improved.

In addition to the above-described embodiment, or in place of the above-described embodiment, the switch unit may include a first switch and a second switch different from the first switch.

According to this embodiment, by providing the two switches, the user can easily cause the power tool to execute a plurality of functions.

In addition to the above-described embodiment, or in place of the above-described embodiment, the motor may include a motor shaft configured to rotate around a motor rotation axis. The motor rotation axis may be orthogonal to the drive axis.

According to this embodiment, compared to a power tool in which the motor is housed such that the motor rotation axis is parallel to the drive axis, the front housing can be downsized. Thus, the front end portion of the power tool can be downsized.

### A. First embodiment

### A1. Overall configuration of oscillating tool 100

Hereinafter, an overall configuration of an oscillating tool 100 according to a first embodiment will be described with reference to the drawings. The oscillating tool 100 is an example of a power tool that drives a tip tool 91 to oscillate, and performs a machining operation on a workpiece (not shown in the drawings). The tip tool 91 is a blade, a scraper, a grinding pad, a polishing pad, or the like, for example. A user can select one of these tip tools 91 suitable for a desired machining operation, such as cutting, peeling, grinding, polishing, or the like, attach the selected tip tool 91 to the oscillating tool 100, and perform the machining operation. Note that, in the present embodiment, the description uses an example in which the blade is attached to the oscillating tool 100 as the tip tool 91.

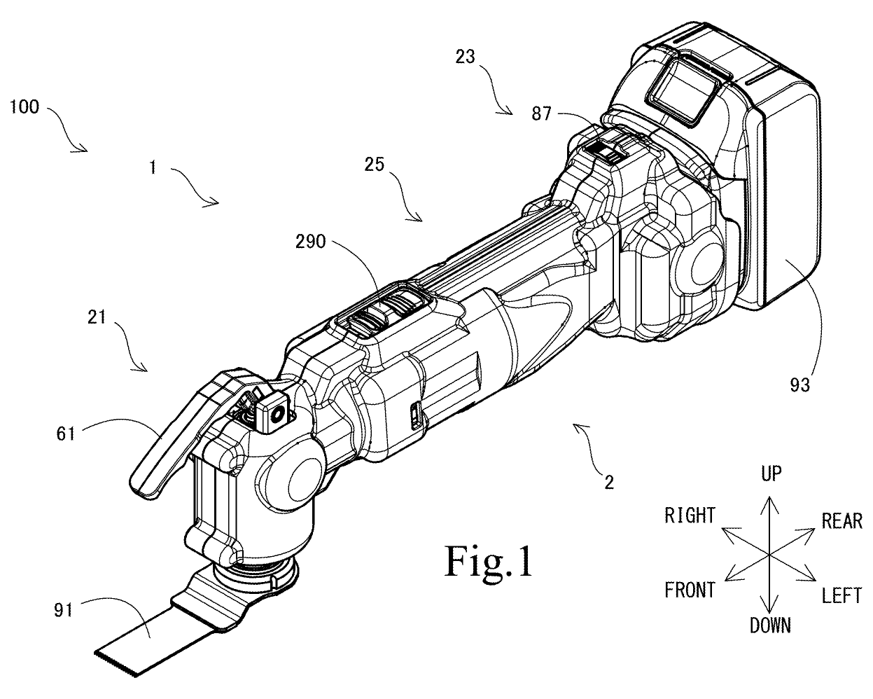

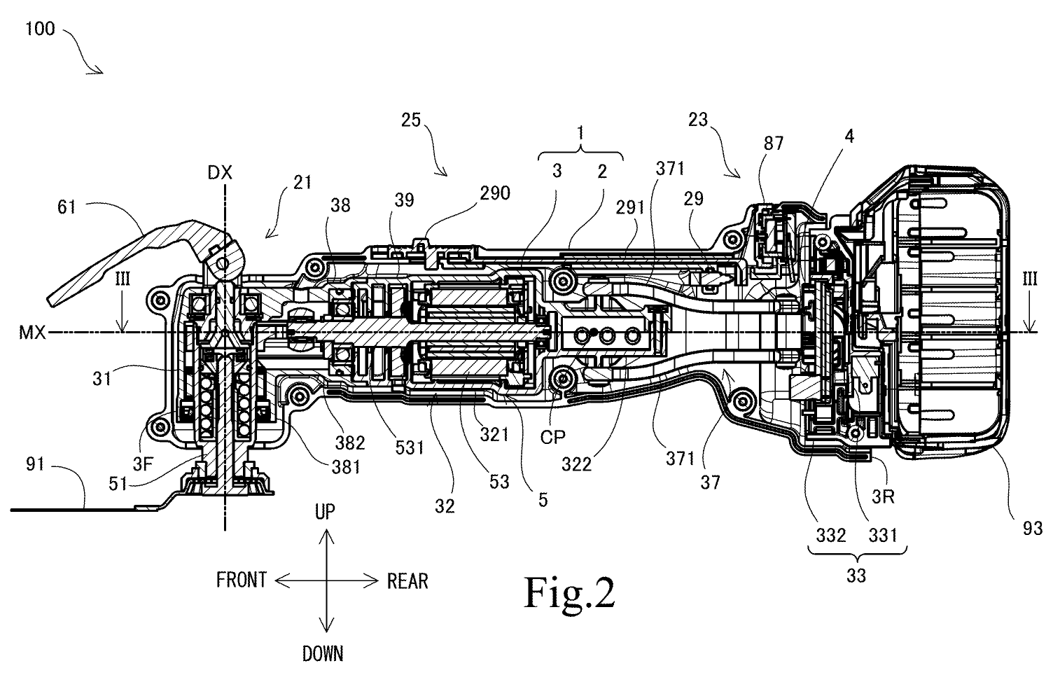

As shown in FIG. 1 and FIG. 2, the oscillating tool 100 includes a housing 1 that has a long shape. In the present embodiment, the housing 1 is configured as a so-called anti-vibration housing having a two-layer structure. The housing 1 includes a long outer housing 2 forming an outer contour of the oscillating tool 100, and a long inner housing 3 housed in the outer housing 2.

As shown in FIG. 2, a spindle 51, a motor 53, and the like are housed in the inner housing 3. A rotation axis MX of an output shaft 531 of the motor 53 is disposed in parallel to an extending direction of the housing 1. A drive axis DX of the spindle 51 is disposed to be orthogonal to the extending direction of the housing 1. One end portion of the spindle 51 protrudes from the housing 1 in the drive axis DX direction, and is exposed to the outside. The tip tool 91 can be detachably attached to the protruding section of the spindle 51. A battery 93 that can supply power to the motor 53 is detachably attached to another end in the extending direction of the housing 1. The oscillating tool 100 is configured to cause the tip tool 91 to oscillate in an oscillation plane orthogonal to the drive axis DX, by causing the spindle 51 to reciprocate and rotate, using the power of the motor 53, within a predetermined angle range around the drive axis DX.

In the following description, as necessary, in relation to directions of the oscillating tool 100, an extending direction of the drive axis DX of the spindle 51 is defined as the up-down direction, the one end side of the spindle 51 to which the tip tool 91 is attached is defined as the lower side, and the opposite side is defined as the upper side. Further, the direction corresponding to the rotation axis MX of the output shaft 531 is defined as the front-rear direction, one end side of the inner housing 3 in which the spindle 51 is housed is defined as the front side, and the opposite end side to which the battery 93 is attached is defined as the rear side. A direction orthogonal to the up-down direction and the front-rear direction is defined as the left-right direction. When the blade shown in the drawings as the tip tool 91 is attached, an oscillation direction of the tip tool 91 roughly corresponds to the left-right direction.

### A2. Configuration of outer housing 2

As shown in FIG. 1 to FIG. 3, the outer housing 2 houses the inner housing 3. As shown in FIG. 1, in the present embodiment, the outer housing 2 includes a front end portion 21, a rear end portion 23, and a central portion 25 connecting the front end portion 21 and the rear end portion 23.

The front end portion 21 has a substantially circular cylindrical shape extending in the up-down direction. The front end portion 21 houses a front housing 31 of the inner housing 3. An operation lever 61, which operates a lock mechanism 6, is provided at an upper front end portion of the front end portion 21.

The rear end portion 23 is formed in a cylindrical shape whose diameter increases toward the rear. In other words, the rear end portion 23 is configured such that the outer shape of a cross-section thereof orthogonal to the rotation axis MX becomes larger the further toward the rear. The rear end portion 23 mainly houses a rear housing 33 of the inner housing 3. At the upper end portion of the rear end portion 23, a dial 87 is held in a state in which an upper side section of the dial 87 is exposed to the outside. The dial 87 is configured as an operation device that receives a rotation operation by the user, and sets a rotational speed of the motor 53 in a stepless manner.

The central portion 25 is formed between the front end portion 21 and the rear end portion 23. The central portion 25 is formed in a roughly uniform cylindrical shape, and extends in a straight line in the front-rear direction. In a radial direction centering on the rotation axis MX, the central portion 25 is disposed further to the outer side than an elastic coupling portion 37, and mainly houses the elastic coupling portion 37. In the present embodiment, as shown in FIG. 2, in the front-rear direction, the central portion 25 is disposed between the front housing 31 and the rear housing 33, and also houses a motor housing 32 in addition to the elastic coupling portion 37.

The central portion 25 has a function as a grip portion that can be held by the user. The central portion 25 is formed to be narrower than the front end portion 21 and the rear end portion 23, in order to be more easily held by the user. Note that, hereinafter, the central portion 25 is also referred to as the “grip portion 25”. A switch knob 290 configured to be manually operable by the user is provided on the upper surface of the central portion 25.

In the present embodiment, a configuration is adopted in which the extending direction of the grip portion 25 is aligned with the extending direction of the inner housing 3, and a center axis of the grip portion 25 is aligned with a center axis of the inner housing 3. The “center axis of the grip portion 25” refers to a straight line based on a center of a cross-sectional shape of the grip portion 25. The “cross-sectional shape of the grip portion 25” refers to the outer shape of the grip portion 25 in a cross-section orthogonal to the front-rear direction. The “center of the cross-sectional shape” also includes a centroid of the cross-sectional shape, or a center of gravity of the cross-sectional shape. For example, the center of gravity of the cross-sectional shape of the grip portion 25 can be defined as the center of the cross-sectional shape of the grip portion 25. In the present embodiment, the center axes of the grip portion 25 and of the inner housing 3 are substantially aligned with the rotation axis MX. Further, in the present embodiment, the center axes of the grip portion 25 and the inner housing 3 are aligned with the rotation axis MX. Note that the center axis of the grip portion 25 may be defined as a straight line joining the center of the cross-sectional shape of the grip portion 25 at the front end of the grip portion 25 and the center of the cross-sectional shape of the grip portion 25 at the rear end of the grip portion 25. Note that the center of the cross-sectional shape of the grip portion 25 over a plurality of locations may be extracted, and the center axis of the grip portion 25 may be defined as a straight line derived using linear regression analysis or the like from the plurality of extracted centers.

### A3. Configuration of inner housing 3

As shown in FIG. 2 to FIG. 4, the inner housing 3 includes the front housing 31, the motor housing 32, the rear housing 33, and the elastic coupling portion 37. Of the inner housing 3, the front housing 31 and the motor housing 32 are formed by coupling together a metal housing 38 and a resin housing 39 that are formed as separate bodies.

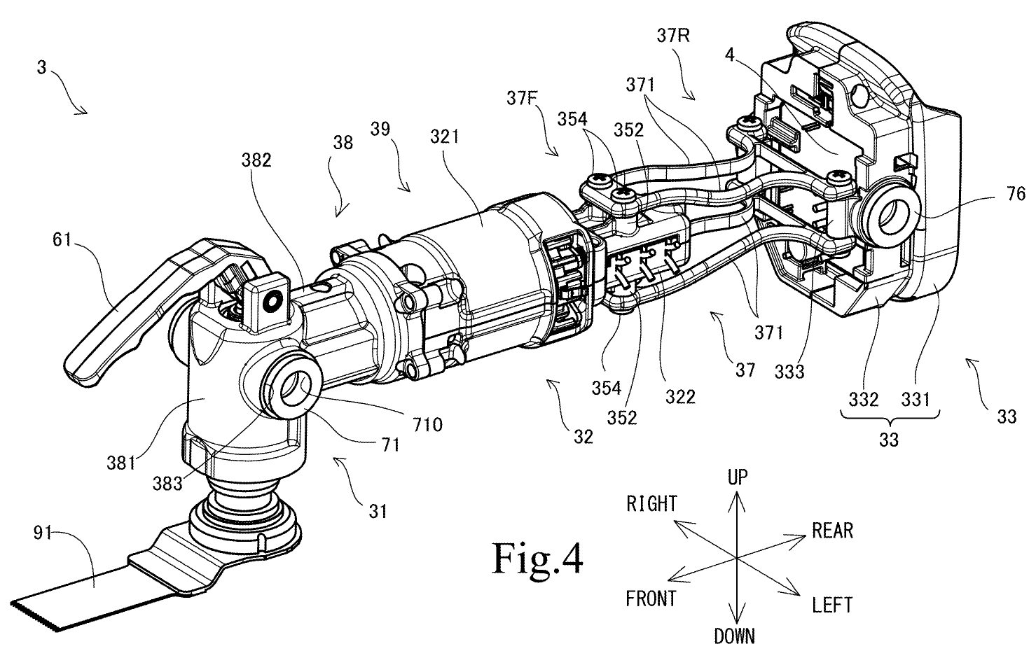

As shown in FIG. 2 and FIG. 4, the metal housing 38 has a substantially L shape including a first section 381 extending in the up-down direction, and a second section 382 extending in the front-rear direction. The first section 381 houses the spindle 51, and functions as the front housing 31. The second section 382 houses a transmission mechanism 55 to be described later. Further, the second section 382 houses the front end of the output shaft 531 of the motor 53, and functions as a part of the motor housing 32. The front end of the motor housing 32 can be defined as a position of the front end of the output shaft 531 of the motor 53, for example. Note that, in the present embodiment, in the front-rear direction, the front end of the motor housing 32 and the front end of the grip portion 25 of the outer housing 2 are at substantially the same position.

The resin housing 39 is made of synthetic resin. The resin housing 39 extends in the front-rear direction. The front end portion of the resin housing 39 is coupled to a rear end portion of the second section 382 of the metal housing 38, using screws that are not shown. The resin housing 39 houses roughly all of the motor 53, and functions as the motor housing 32.

The motor housing 32 includes a circular cylindrical portion 321 housing the motor 53, and an extending portion 322 extending to the rear from the rear end of the circular cylindrical portion 321. The extending portion 322 has a substantially cuboid shape. A lead wire, a connection terminal, and the like for connecting the motor 53 and a controller 4 to be described later are disposed in the extending portion 322. As shown in FIG. 4, the extending portion 322 includes protrusions 352 protruding toward the outer side in the radial direction centering on the rotation axis MX.

The whole of the motor housing 32 is housed in the grip portion 25 of the outer housing 2. In the present embodiment, the motor 53 is housed in the motor housing 32 such that the rotation axis MX of the output shaft 531 of the motor 53 is orthogonal to the drive axis DX of the spindle 51. Thus, compared to a case in which the motor 53 is housed such that the rotation axis MX is parallel to the drive axis DX, the front housing 31 is downsized by an amount corresponding to not housing the motor 53. As a result, the front end portion 21 of the oscillating tool 100 can be downsized. Further, since the motor housing 32 has the shape that is long in the front-rear direction, it is possible to suppress or prevent the grip portion 25 from becoming thicker while housing the motor housing 32 in the grip portion 25. Thus, compared to the case in which the motor 53 is housed such that the rotation axis MX is parallel to the drive axis DX, the grip portion 25 can be made thinner and longer in the front-rear direction. As a result, the grip portion 25 can be favorably held, and portability of the oscillating tool 100 can be improved.

As shown in FIG. 2 to FIG. 4, the rear housing 33 is the rear end portion of the inner housing 3, and has a roughly square cylindrical shape. In the present embodiment, a battery attachment portion 331 with which the battery 93 can be slidingly engaged, is provided at the rear side of the rear housing 33. A power receiving terminal and the like that can be electrically connected to a power supply terminal of the battery 93 are provided in the battery attachment portion 331.

A controller housing portion 332 that houses the controller 4 is provided at the front side of the rear housing 33. The controller 4 includes a circuit board on which are mounted a CPU as a processor controlling driving of the motor 53, storage devices such as a RAM, a ROM, and the like, and switching terminals and the like that operate based on control signals from the CPU.

The elastic coupling portion 37 extends in the front-rear direction, and is elastically coupled to the rear end of the motor housing 32 and the front end of the rear housing 33. Specifically, a front end portion 37F of the elastic coupling portion 37 is coupled to the motor housing 32, and a rear end portion 37R is coupled to the rear housing 33. An elastic member 371 can effectively suppress the transmission of vibrations from the front housing 31 to the rear housing 33.

The elastic coupling portion 37 includes a plurality of the elastic members 371 that are coupled to the motor housing 32 and the rear housing 33 in the front-rear direction. The plurality of elastic members 371 are arranged at intervals from each other in a peripheral direction around the rotation axis MX of the output shaft 531 of the motor 53 (or around the center axis of the inner housing 3). In the present embodiment, four of the elastic members 371 are provided that are separated from each other in the up-down direction.

Each of the elastic members 371 is formed in a band shape that easily elastically deforms (easily deflects). Thus, each of the elastic members 371 is configured to easily elastically deform, compared to other sections of the inner housing 3. Further, each of the elastic members 371 is formed of a material having a lower modulus of elasticity than the other sections of the inner housing 3. For example, the other sections of the inner housing 3 are formed of glass fiber-reinforced polyamide, and the elastic members 371 are formed of polyacetal that does not contain reinforced fibers. Note that the material of the elastic members 371 is not limited to this example. For example, when the other sections are formed of the glass fiber-reinforced polyamide, the elastic members 371 may be formed of polycarbonate or ABS resin.

### A4. Configuration of drive mechanism 5

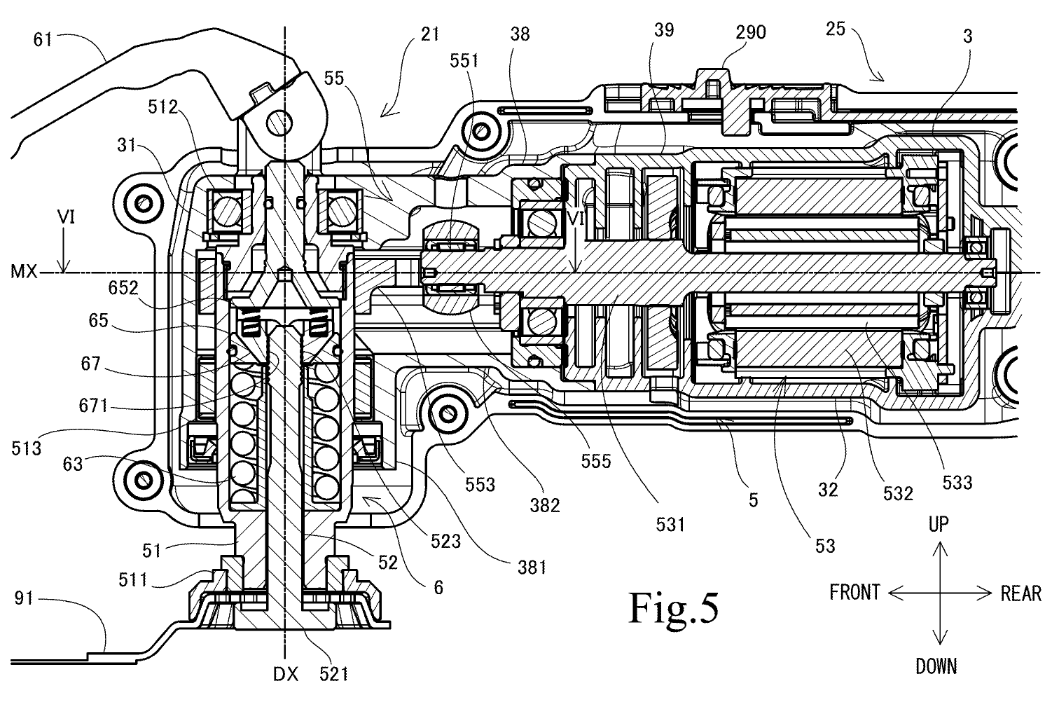

As shown in FIG. 5, a drive mechanism 5 and the lock mechanism 6 are provided in the front housing 31 and the motor housing 32 of the inner housing 3. The drive mechanism 5 is a mechanism for driving the tip tool 91 to oscillate. The drive mechanism 5 includes the spindle 51, the motor 53, and the transmission mechanism 55.

The spindle 51 is a long member having a substantially circular cylindrical shape. In the present embodiment, the spindle 51 is housed in the front housing 31, and is rotatably supported by two bearings 512 and 513 around the drive axis DX. At the lower end portion of the spindle 51 exposed to the outside from the housing 1, the spindle 51 includes a tool attachment portion 511 that is configured for the tip tool 91 to be detachably attached thereto. In the present embodiment, the tip tool 91 is clamped between the tool attachment portion 511 and a clamp head 521 of a clamp shaft 52.

The motor 53 is housed in the motor housing 32. The motor 53 is a brushless DC motor, and includes a stator 532, a rotor 533 disposed on an inner side of the stator 532 in the radial direction, and the output shaft 531 that rotates integrally with the rotor 533. The rotation axis MX of the output shaft 531 of the motor 53 is orthogonal to the drive axis DX of the spindle 51, and extends in parallel to the front-rear direction and the extending direction of the inner housing 3.

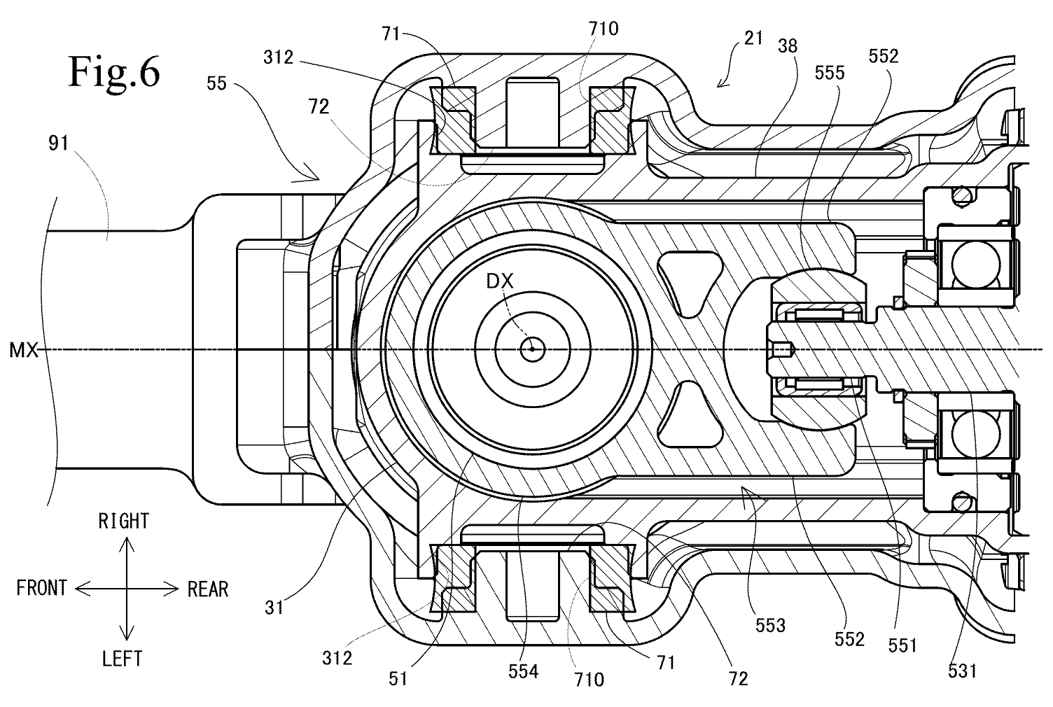

As shown in FIG. 5 and FIG. 6, the transmission mechanism 55 is disposed over the front housing 31 and the motor housing 32. The transmission mechanism 55 is configured to transmit a rotational movement of the motor 53 to the spindle 51, and to cause the spindle 51 to reciprocate and rotate within the predetermined angle range around the drive axis DX. The transmission mechanism 55 includes an eccentric shaft 551, a coupling arm 553, and a drive bearing 555.

The eccentric shaft 551 is connected to the front end of the output shaft 531 of the motor 53. The eccentric shaft 551 extends toward the front from the front end of the output shaft 531, at a position offset to the outer side in the radial direction from the rotation axis MX. As a result of the rotation of the output shaft 531, the eccentric shaft 551 rotates around the rotation axis MX at the position offset to the outer side in the radial direction from the rotation axis MX.

The drive bearing 555 is attached to an outer peripheral portion of the eccentric shaft 551. The outer peripheral surface of the drive bearing 555 has a curved surface shape, with a central section in the front-rear direction that bulges toward the outer side in the radial direction. The drive bearing 555 is also referred to as a sphere bearing.

The coupling arm 553 is a member that couples the drive bearing 555 and the spindle 51. Specifically, one end of the coupling arm 553 is fixed to the spindle 51, and the other end is connected to the drive bearing 555. The coupling arm 553 reciprocates and rotates with the spindle 51 as a fulcrum, as a result of the rotational movement of the eccentric shaft 551.

An annular portion 554 is formed in an annular shape at the front end of the coupling arm 553, and a pair of arm portions 552 are formed at the rear end of the coupling arm 553. The annular portion 554 is fixed to the outer periphery of the upper end portion of the spindle 51. The pair of arm portions 552 are disposed so as to be in contact with outer peripheral portions of the drive bearing 555. The coupling arm 553 is coupled to the eccentric shaft 551 as a result of the pair of arm portions 552 clamping the drive bearing 555 in the left-right direction.

When the motor 53 is driven, the eccentric shaft 551 rotates integrally with the output shaft 531. When the eccentric shaft 551 rotates around the rotation axis MX, the drive bearing 555 also moves around the rotation axis MX. In the eccentric rotation movement of the eccentric shaft 551, the eccentric shaft 551 rotates around the rotation axis MX at the center of the rotation. Due to the eccentric rotation movement of the eccentric shaft 551, the pair of arm portions 552 of the coupling arm 553 rotate while oscillating in the left-right direction.

The oscillation of the pair of arm portions 552 in the left-right direction is transmitted to the spindle 51 via the annular portion 554, and the spindle 51 reciprocates and rotates in the peripheral direction around the drive axis DX. As a result, the tip tool 91 fixed to the tool attachment portion 511 of the spindle 51 oscillates around the drive axis DX. An angle of oscillation of the tip tool 91 centering on the drive axis DX is, for example, in a range from around 1 degree to 5 degrees. Note that one cycle of the rotational movement of the eccentric shaft 551 is converted to one back-and-forth oscillation movement of the tip tool 91.

### A5. Configuration of lock mechanism 6

As shown in FIG. 5, the lock mechanism 6 is configured to be able to lock the clamp shaft 52 at a clamped position at which the tip tool 91 can be clamped between the clamp shaft 52 and the spindle 51. The clamp shaft 52 is a member having a substantially circular columnar shape, and is long in the up-down direction. The clamp shaft 52 is configured to be able to be inserted into the spindle 51 coaxially with the spindle 51. The clamp head 521 is formed at the lower end portion of the clamp shaft 52, and a groove portion 523 is formed in the upper end portion of the clamp shaft 52.

The lock mechanism 6 includes a compression coil spring 63, a collar 65, and a pair of clamp members 67. The collar 65 is formed in an annular shape, and is urged in the upward direction by the compression coil spring 63 disposed inside the spindle 51. The pair of clamp members 67 are disposed inside the collar 65 in a state of being urged in the downward direction by a spring 652. Convex portions 671 are formed on surfaces of the pair of clamp members 67 facing each other.

The lock mechanism 6 is configured to operate in conjunction with a manual operation of the operation lever 61 by the user. When the operation lever 61 is disposed at a lock position, the collar 65 is urged in the upward direction by the compression coil spring 63. The clamp members 67 move to the inner side in the radial direction of the collar 65, along an inclined surface formed at the inner peripheral surface of the collar 65. As a result, the convex portions 671 of the clamp members 67 engage with the groove portion 523 in the clamp shaft 52, and the clamp shaft 52 is clamped by the clamp members 67. When the clamp shaft 52 is urged in the upward direction by the compression coil spring 63 in this state and is locked at the clamped position, the tip tool 91 is clamped between the tool attachment portion 511 and the clamp head 521, and is fixed to the spindle 51.

When the operation lever 61 is disposed at a lock release position, the contact between the inclined surface of the collar 65 and inclined surfaces of the clamp members 67 is released, and the clamp members 67 are in a state of being able to move to the outer side in the radial direction. The locking of the clamp shaft 52 is released, and the user can remove the clamp shaft 52 from the spindle 51 and can attach or detach the tip tool 91.

### A6. Elastic coupling structure between outer housing 2 and inner housing 3

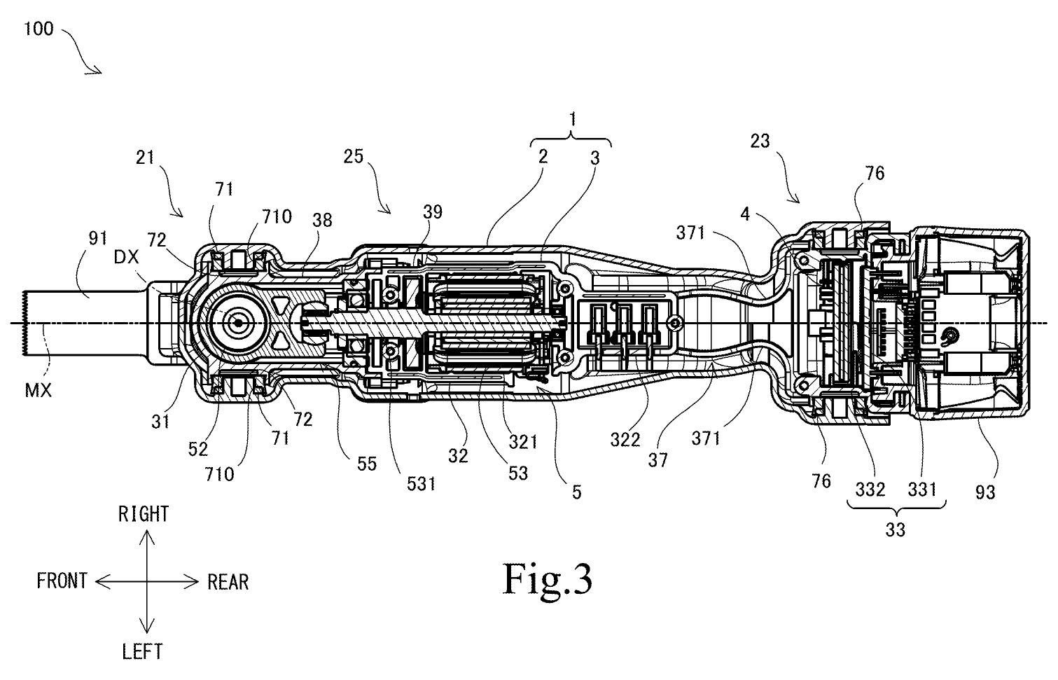

As shown in FIG. 3 and FIG. 4, the outer housing 2 and the inner housing 3 are coupled to each other by elastic members at a plurality of positions in the front-rear direction. More specifically, two front elastic members 71 are provided between the front end portion 21 of the outer housing 2 and the front housing 31 of the inner housing 3. Two rear elastic members 76 are provided between the rear end portion 23 of the outer housing 2 and the rear housing 33 of the inner housing 3. The front elastic members 71 and the rear elastic members 76 are, for example, formed of an elastic material such as urethane foam, rubber, or the like.

As shown in FIG. 4, the front elastic members 71 have a substantially annular shape, and are fitted into substantially circular recesses 383 formed in the outer surface of the front housing 31. The front elastic members 71 and the recesses 383 are provided to be left-right symmetrical on the left side and the right side of the front housing 31.

As shown in FIG. 6, the front elastic members 71 are coupled to coupling members 72 formed at the outer housing 2. The coupling members 72 are sections protruding toward the inner housing 3 from the inner peripheral surface of the outer housing 2. The coupling members 72 are fitted into through holes 710 of the front elastic members 71, and the outer peripheral surfaces of the coupling members 72 are covered by the front elastic members 71 over the whole periphery thereof. Further, the tip ends of the coupling members 72 are disposed in gaps between the coupling member 72 and the front housing 31. As a result of this type of configuration, the coupling members 72 are configured to be able to move relatively inside the recesses 383, while compressing the front elastic members 71 in all of the up-down direction, the front-rear direction, and the left-right direction. In this way, the front end portion 21 of the outer housing 2 is coupled to the front housing 31 of the inner housing 3 in a state of being able to move relatively in all directions via the front elastic members 71. In a similar manner to the front end portion 21, the rear end portion 23 of the outer housing 2 is coupled to the rear housing 33 of the inner housing 3 in a state of being able to move relatively in all directions via the rear elastic members 76. According to the above-described configuration, when the tip tool 91 is being driven to oscillate, the transmission of vibrations from the inner housing 3 to the outer housing 2 can be effectively reduced.

In the oscillating tool 100 according to the present embodiment, the elastic coupling portion 37 coupling the motor housing 32 and the rear housing 33 further suppresses the transmission of vibrations from the front housing 31 to the rear housing 33. The elastic coupling portion 37 can more effectively suppress the transmission of the vibrations from the motor housing 32 to the rear housing 33 by being formed so as to have a lower elastic force than that of the motor housing 32 and the rear housing 33.

By the elastic coupling portion 37, the vibrations transmitted from the front housing 31 to the rear housing 33 can be reduced compared to a time point at which the vibrations are generated in the front housing 31. Further, the rear housing 33 is coupled to the outer housing 2 via the rear elastic members 76, as described above. Thus, compared to a case in which the outer housing 2 is coupled to a section other than the rear housing 33, such as to the motor housing 32 or the like, the vibrations transmitted from the inner housing 3 to the outer housing 2 can be reduced.

### A7. Arrangement configuration of elastic coupling portion 37

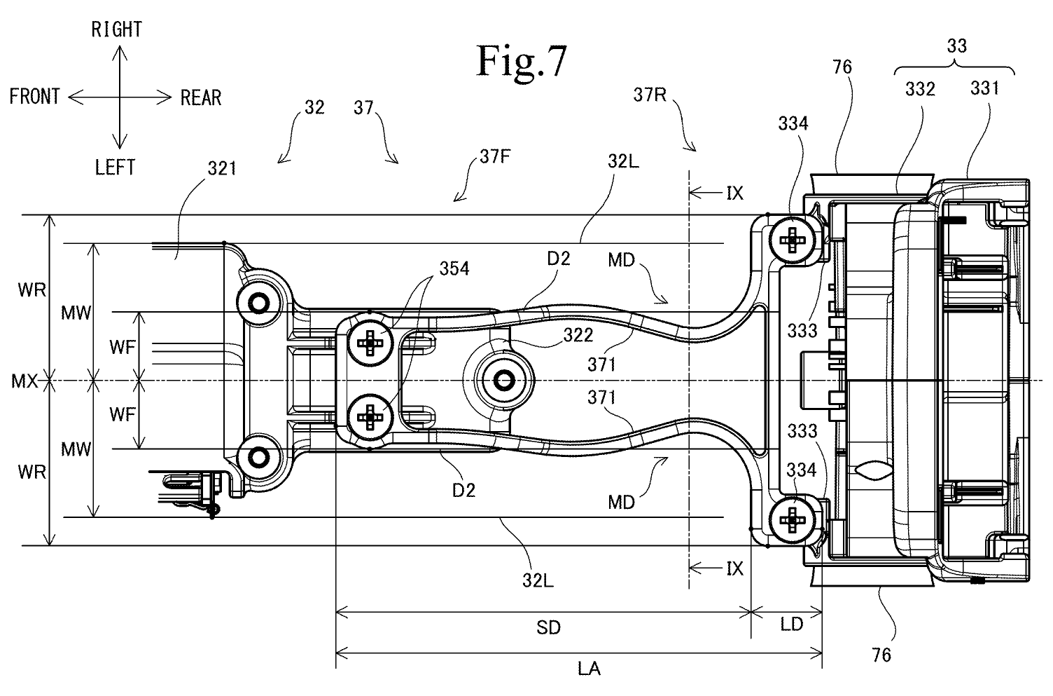

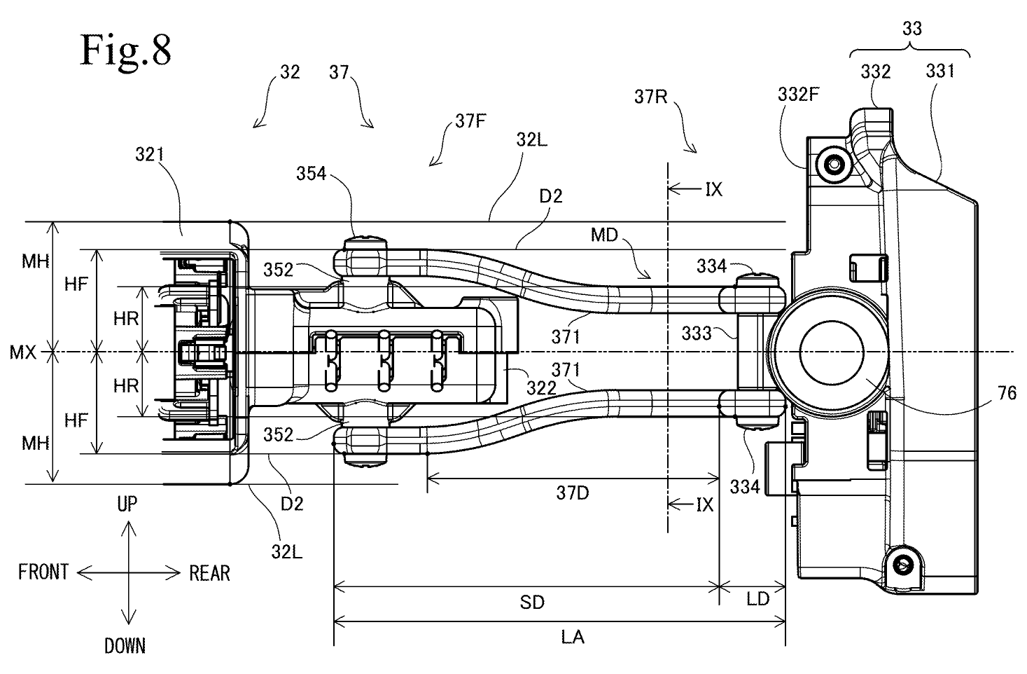

As shown in FIG. 4, FIG. 7 and FIG. 8, the elastic coupling portion 37 extends in the front-rear direction, and elastically couples the rear end of the motor housing 32 and the front end of the rear housing 33. Note that, in FIG. 7 and FIG. 8, the battery 93 is not shown.

As shown in FIG. 7 and FIG. 8, the front end portion 37F of the elastic coupling portion 37 is connected to the rear end portion of the motor housing 32. More specifically, the front end portion 37F is coupled to the protrusions 352 of the extending portion 322 of the motor housing 32, by screws 354. Note that the front end portion 37F may be coupled to the circular cylindrical portion 321, instead of the extending portion 322. The elastic coupling portion 37 is not limited to the case of being formed as a separate body from the motor housing 32, and may be formed integrally with the motor housing 32. In this case, the elastic coupling portion 37 can be coupled to the motor housing 32 without using the screws 354.

The rear end portion 37R of the elastic coupling portion 37 is connected to the rear housing 33. More specifically, the rear end portion 37R is coupled to protruding portions 333 protruding to the front from the controller housing portion 332 of the rear housing 33, by screws 334. Note that the rear end portion 37R may be coupled to a front surface 332F of the controller housing portion 332, instead of the protruding portions 333. The elastic coupling portion 37 is not limited to the case of being formed as a separate body from the rear housing 33, and may be formed integrally with the rear housing 33. In this case, the elastic coupling portion 37 can be coupled to the rear housing 33 without using the screws 334.

In the present embodiment, apart from the rear end portion 37R, the elastic coupling portion 37 is disposed in a region further to the inner side than a contour 32L of the motor housing 32 when the oscillating tool 100 is viewed in the front-rear direction. Of the elastic coupling portion 37, the section disposed further to the inside than the contour 32L of the motor housing 32 will also be referred to as a “small diameter portion”.

As shown in FIG. 7, in the left-right direction, apart from the rear end portion 37R, the elastic coupling portion 37 is disposed in a region further to the inner side than both ends of the circular cylindrical portion 321 of the motor housing 32. Specifically, in the left-right direction, a distance WF from the rotation axis MX to the right end of the front end portion 37F is configured to be shorter than a distance MW from the rotation axis MX to the right end of the motor housing 32. In contrast, a distance WR from the rotation axis MX to the right end of the rear end portion 37R is larger than the distance WF and is larger than the distance MW. Of the elastic coupling portion 37, a section disposed in a region further to the outer side than the contour 32L of the motor housing 32 will also be referred to as a “large diameter portion”. Note that, for ease of understanding of the technology, a lead wire 88 is not shown in FIG. 7.

As shown in FIG. 7, in the elastic coupling portion 37, the rear end portion 37R is a large diameter portion LD, and a section from the front end portion 37F to immediately before the rear end portion 37R is a small diameter portion SD. The small diameter portion SD occupies half or more of a total length LA of the elastic coupling portion 37 in the front-rear direction from the front end portion 37F to the rear end portion 37R. In this way, almost all of sections of the elastic members 371 are disposed in the region further to the inner side than the contour 32L of the motor housing 32. Note that the same configuration as that described above applies also to the left side from the rotation axis MX.

As shown in FIG. 7, in the present embodiment, the elastic coupling portion 37 includes a minimum diameter portion MD immediately to the front of the rear end portion 37R. The minimum diameter portion MD is a section of the elastic coupling portion 37 at which the distance from the rotation axis MX to the elastic member 371 is a shortest distance. The minimum diameter portion MD is referred to as a narrow section of the elastic coupling portion 37.

As shown in FIG. 8, in the up-down direction, the front end portion 37F and the rear end portion 37R of the elastic coupling portion 37 are disposed in the region further to the inner side than the both ends of the circular cylindrical portion 321. Specifically, in the up-down direction, a distance HF from the rotation axis MX to the upper end of the front end portion 37F is configured to be shorter than a distance MH from the rotation axis MX to the upper end of the motor housing 32. In other words, when the oscillating tool 100 is viewed from the side, the distance from the rotation axis MX to the elastic coupling portion 37 is configured to be closer at the rear end portion 37R than at the front end portion 37F. Further, a distance HR from the rotation axis MX to the upper end of the rear end portion 37R is shorter than the distance MH, and is shorter than the distance HF. Note that the same configuration as that described above applies also to the lower side from the rotation axis MX.

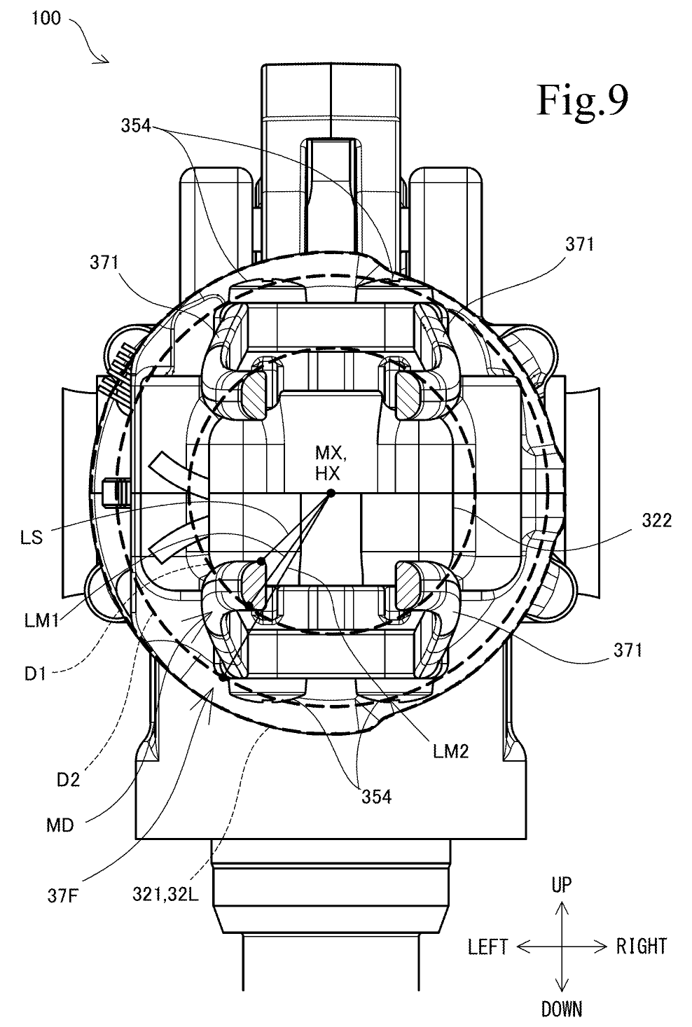

In FIG. 9, the motor housing 32 and the elastic coupling portion 37 are shown when the oscillating tool 100 is viewed from the rear. Further, for convenience of understanding, the contour 32L of the motor housing 32 is schematically indicated using a broken line. As shown in FIG. 9, apart from the rear end portion 37R, the elastic coupling portion 37 is disposed in the region further to the inner side than the contour 32L of the motor housing 32. In other words, apart from the rear end portion 37R, the elastic coupling portion 37 is configured to be the small diameter portion SD.

As indicated by a circle D1 in FIG. 9, a maximum distance from the elastic coupling portion 37 at an arbitrary position further to the rear than the front end portion 37F to the rotation axis MX is defined as a first largest distance LM1. Note that, in the example in FIG. 9, the first largest distance LM1 is shown in the minimum diameter portion MD. Further, as indicated by a circle D2, a maximum distance from the elastic coupling portion 37 in the front end portion 37F to the rotation axis MX is defined as a second largest distance LM2. Note that since the distances from the four elastic members 371 to the rotation axis MX are substantially the same, the description is made using one of the elastic members 371.

As shown in FIG. 8, in the present embodiment, the elastic coupling portion 37 further includes a reducing diameter portion 37D. The reducing diameter portion 37D is a section at which the first largest distance LM1 is shorter than the second largest distance LM2. In the example in FIG. 9, the reducing diameter portion 37D is a section disposed further to the inner side than the circle D2 indicated by a broken line, of the elastic coupling portion 37. In other words, the elastic coupling portion 37 is configured for the diameter thereof to reduce from the front end portion 37F toward the rear until reaching the rear end portion 37R. The elastic coupling portion 37 is configured such that the section apart from the maximum diameter portion LD of the rear end portion 37R is the reducing diameter portion 37D. By being configured in such a way, the grip portion 25 can be made narrower, compared to a case in which the diameter of the elastic coupling portion 37 increases toward the rear. Thus, it is possible to provide the oscillating tool 100 having high portability while having a high anti-vibration capability.

Note that, a shortest distance LS in the minimum diameter portion MD from the rotation axis MX to the elastic member 371 is configured to be half or less of the second largest distance LM2 in the front end portion 37F from the rotation axis MX to the elastic member 371. By providing the minimum diameter portion MD, the strength of the elastic coupling portion 37 can be improved while making the elastic coupling portion 37 even narrower.

A8. Arrangement configuration of switch knob 290 and switch 29

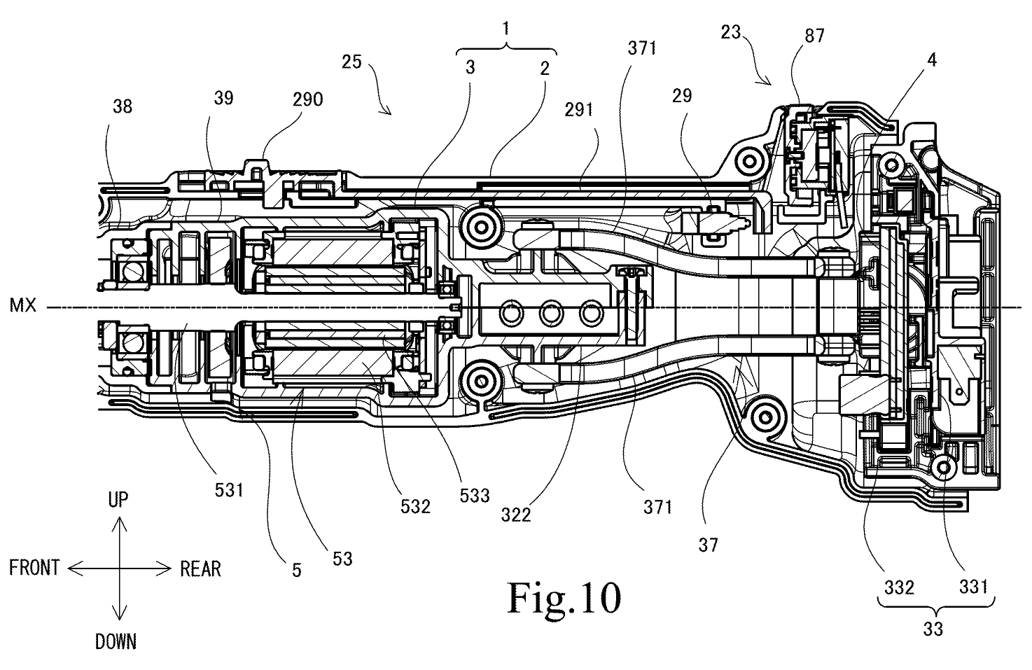

As shown in FIG. 10, the switch knob 290 configured to be manually operable by the user is provided on the upper surface of the central portion 25, immediately above the motor 53. The switch knob 290 is configured to be able to slide in the front-rear direction by the manual operation. A switch lever 291 that extends in the front-rear direction is coupled to the switch knob 290. The switch lever 291 is disposed between the inner housing 3 and the outer housing 2. The switch lever 291 moves between an on position and an off position in accordance with the operation of the switch knob 290, and switches a switch 29 on and off. The switch 29 is a so-called microswitch.

The user attaches the tip tool 91 that accords with the desired machining operation to the tool attachment portion 511 (refer to FIG. 5), holds the grip portion 25, and switches the switch knob 290 to the on position. In this way, the switch 29 is turned on via the switch lever 291. The controller 4 starts the driving of the motor 53 in accordance with the switch 29 being turned on. As a result of the driving of the motor 53, the spindle 51 reciprocates and rotates around the drive axis DX within the predetermined angle range, and causes the tip tool 91 to oscillate in roughly the left-right direction. The user can perform the machining operation using the oscillating tool 100, by pressing the tip tool 91 against the workpiece. Note that the controller 4 can further set the rotation speed of the motor 53 based on a resistance value set via the dial 87.

As shown in FIG. 10, in the oscillating tool 100 according to the present embodiment, the switch knob 290 is provided at the upper half of the outer housing 2. More specifically, the switch knob 290 is disposed further upward than the rotation axis MX of the motor 53. Thus, the user can easily see the switch knob 290 from above the oscillating tool 100, and can easily operate the switch knob 290.

The switch knob 290 is disposed at the front half section of the oscillating tool 100. More specifically, the switch knob 290 is disposed further to the front than a center point of the inner housing 3 in the front-rear direction. The center point of the inner housing 3 in the front-rear direction refers to an intermediate position between the front end 3F of the front housing 31 and the rear end 3R of the rear housing 33, as indicated by a center point CP in FIG. 2. By being configured in such a way, the user can easily see the switch knob 290 while holding the grip portion 25, and can easily operate the switch knob 290.

As shown in FIG. 10, the switch 29 is provided at the upper half of the outer housing 2. More specifically, the switch 29 is disposed further upward than the rotation axis MX of the motor 53. By being configured in this way, a distance between the switch knob 290 and the switch 29 can be shortened, and a member joining the switch knob 290 and the switch 29, such as the switch lever 291 or the like, can be downsized. As a result, it is possible to suppress or prevent the grip portion 25 from becoming thicker.

In the present embodiment, the switch 29 is disposed further to the outer side than the elastic coupling portion 37 in the radial direction centering on the rotation axis MX of the motor 53. By being configured in this way, compared to a configuration in which the switch 29 is disposed at the inner side of the elastic coupling portion 37, it is possible to downsize the elastic coupling portion 37 by forming the small diameter portion SD and the reducing diameter portion 37D in the elastic coupling portion 37, and so on. Thus, it is possible to suppress or prevent the grip portion 25 from becoming thicker. Note that, in the present embodiment, the switch 29 is disposed directly above the reducing diameter portion 37D of the elastic coupling portion 37 (more specifically, directly above the minimum diameter portion MD). As a result of the elastic coupling portion 37 including the small diameter portion SD and the reducing diameter portion 37D, a space formed inside the grip portion 25 can be utilized, and thus, the switch 29 can be efficiently disposed.

As described above, according to the oscillating tool 100 according to the present embodiment, the motor 53 is housed in the motor housing 32 such that the rotation axis MX of the output shaft 531 of the motor 53 is orthogonal to the drive axis DX of the spindle 51. Thus, compared to the case in which the motor 53 is housed such that the rotation axis MX and the drive axis DX are parallel to each other, the front housing 31 can be downsized, and the front end portion 21 of the oscillating tool 100 can be downsized. Further, by forming the motor housing 32 to be long in the front-rear direction, it is possible to suppress or prevent the grip portion 25 from becoming thicker while housing the motor housing 32 in the grip portion 25. Thus, compared to the case in which the motor 53 is housed such that the rotation axis MX and the drive axis DX are parallel to each other, the grip portion 25 can be made narrower, and further made longer in the front-rear direction. The grip portion 25 can be favorably held, and portability of the oscillating tool 100 can be improved.

The elastic coupling portion 37 includes the small diameter portion SD that is disposed in a region further to the inner side than the contour 32L of the motor housing 32 when the oscillating tool 100 is viewed from the rear. The small diameter portion SD occupies half or more of the total length LA of the elastic coupling portion 37 in the front-rear direction. By including the small diameter portion SD, a section of the inner housing 3 including the elastic coupling portion 37 can be made narrower. Thus, the grip portion 25 can be made narrower, and the portability of the oscillating tool 100 can be improved.

The elastic coupling portion 37 further includes the reducing diameter portion 37D in which the first largest distance LM1 becomes shorter than the second largest distance LM2, and is configured for the diameter thereof to reduce from the front end portion 37F toward the rear until reaching the rear end portion 37R. Thus, it is possible to provide the oscillating tool 100 having the high portability having the high anti-vibration capability.

### B. Second embodiment

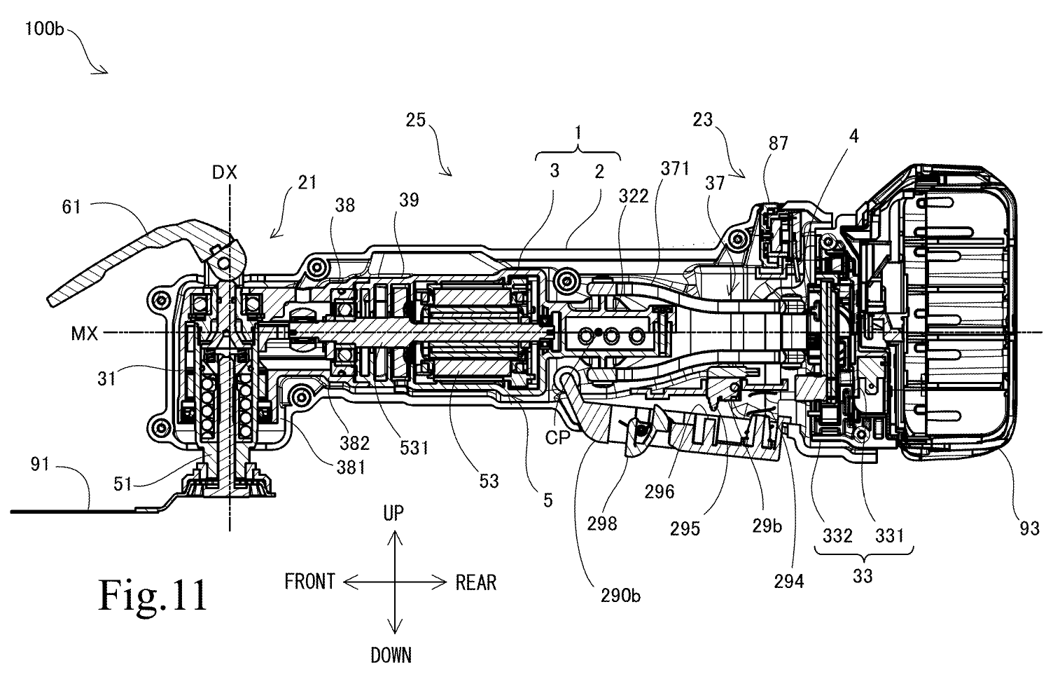

As shown in FIG. 11, an oscillating tool 100b according to a second embodiment differs from the oscillating tool 100 according to the first embodiment in that the oscillating tool 100b includes a switch 29b instead of the switch 29, and includes a paddle switch 290b instead of the switch knob 290. Other configurations are the same.

The paddle switch 290b is provided at the lower half of the outer housing 2. More specifically, the paddle switch 290b is disposed further downward than the rotation axis MX of the motor 53. In the example in FIG. 11, the paddle switch 290b is provided at the lower end of the grip portion 25. The paddle switch 290b is urged toward the outer side of the grip portion 25 by a coil spring 294, and is normally disposed at a stop position at which the motor 53 is stopped.

A pressing portion 296, and a lock-off lever 298 are provided at the paddle switch 290b. When the user presses the paddle switch 290b toward the interior of the grip portion 25 in resistance to the urging force of the coil spring 294, the paddle switch 290b is displaced to an activation position for activating the motor 53. At the activation position, the pressing portion 296 presses in a plunger 295 of the switch 29b.

The lock-off lever 298 normally restricts the displacement of the paddle switch 290b to the activation position. The lock-off lever 298 is configured to be rotatable, and when the lock-off lever 298 is rotated by a manual operation of the user, the displacement of the paddle switch 290b to the activation position is allowed.

An arrangement position of the switch 29b differs from that of the switch 29 according to the first embodiment. In the present embodiment, as shown in FIG. 11, the switch 29b is provided at the lower half of the outer housing 2. More specifically, the switch 29b is disposed further downward than the rotation axis MX of the motor 53. By being configured in this manner, a distance from the paddle switch 290b to the switch 29b can be shortened, and a member joining the paddle switch 290b and the switch 29b can be downsized. As a result, it is possible to suppress or prevent the grip portion 25 from becoming thicker.

In the present embodiment, the switch 29b is disposed further to the outer side than the elastic coupling portion 37 in the radial direction centering on the rotation axis MX of the motor 53. By being configured in this way, compared to a case in which the switch 29b is disposed to the inner side of the elastic coupling portion 37, the elastic coupling portion 37 can be downsized. Thus, it is possible to suppress or prevent the grip portion 25 from becoming thicker, while arranging the elastic coupling portion 37. Note that, in the present embodiment, the switch 29b is disposed directly below the reducing diameter portion 37D of the elastic coupling portion 37 (more specifically, directly below the minimum diameter portion MD). As a result of providing the reducing diameter portion 37D, a space formed outside the elastic coupling portion 37 grip portion can be utilized, and thus, the switch 29b can be efficiently disposed.

### C. Third embodiment

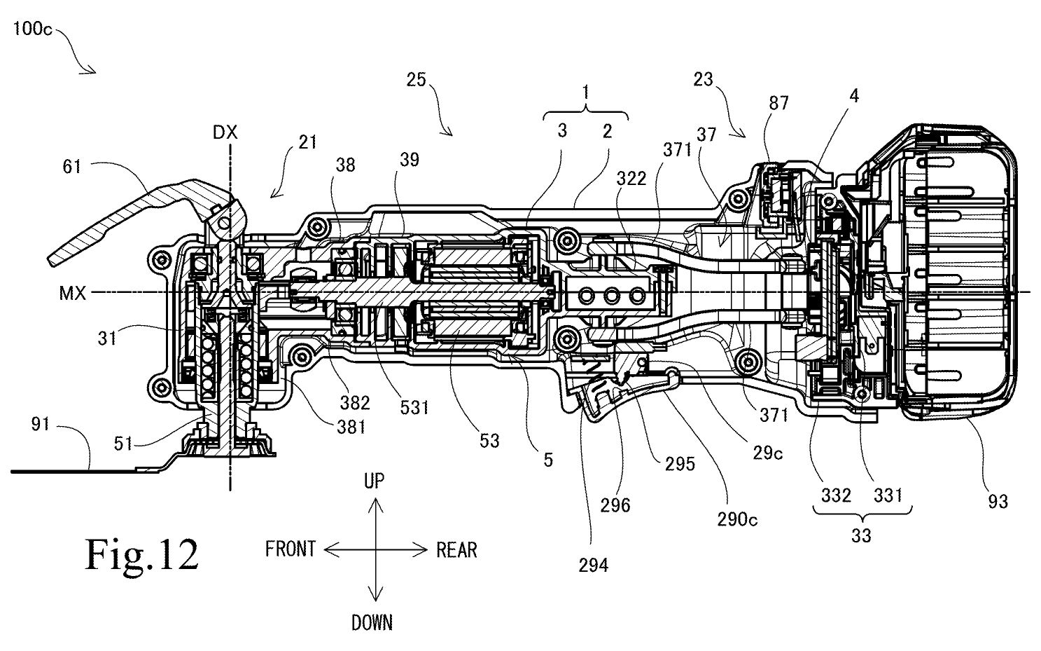

As shown in FIG. 12, an oscillating tool 100c according to a third embodiment differs from the oscillating tool 100 according to the first embodiment in that the oscillating tool 100c includes a switch 29c instead of the switch 29, and includes a trigger switch 290c instead of the switch knob 290. Other configurations are the same.

The trigger switch 290c is provided at the lower half of the outer housing 2. More specifically, the trigger switch 290c is disposed further downward than the rotation axis MX of the motor 53. In the example in FIG. 12, the trigger switch 290c is provided at the lower end of the grip portion 25. The trigger switch 290c is urged toward the outer side of the grip portion 25 by the coil spring 294, and is normally disposed at the stop position at which the motor 53 is stopped.

When the user presses the trigger switch 290c toward the interior of the grip portion 25 in resistance to the urging force of the coil spring 294, the trigger switch 290c is displaced to the activation position for activating the motor 53. At the activation position, the pressing portion 296 presses in the plunger 295 of the switch 29c.

An arrangement position of the switch 29c differs from that of the switch 29. As shown in FIG. 12, the switch 29c is disposed further downward than the rotation axis MX of the motor 53. By being configured in this way, a distance from the trigger switch 290c to the switch 29c can be shortened, and the internal configuration of the grip portion 25 can be simplified.

In the present embodiment, the switch 29c is disposed further to the outer side than the elastic coupling portion 37 in the radial direction centering on the rotation axis MX of the motor 53. By being configured in this way, compared to a case in which the switch 29c is disposed to the inner side of the elastic coupling portion 37, the elastic coupling portion 37 can be downsized, and it is possible to suppress or prevent the grip portion 25 from becoming thicker. Note that, in the present embodiment, the switch 29c is disposed further downward than the elastic coupling portion 37, and more specifically, directly below the front end portion 37F.

### D. Fourth embodiment

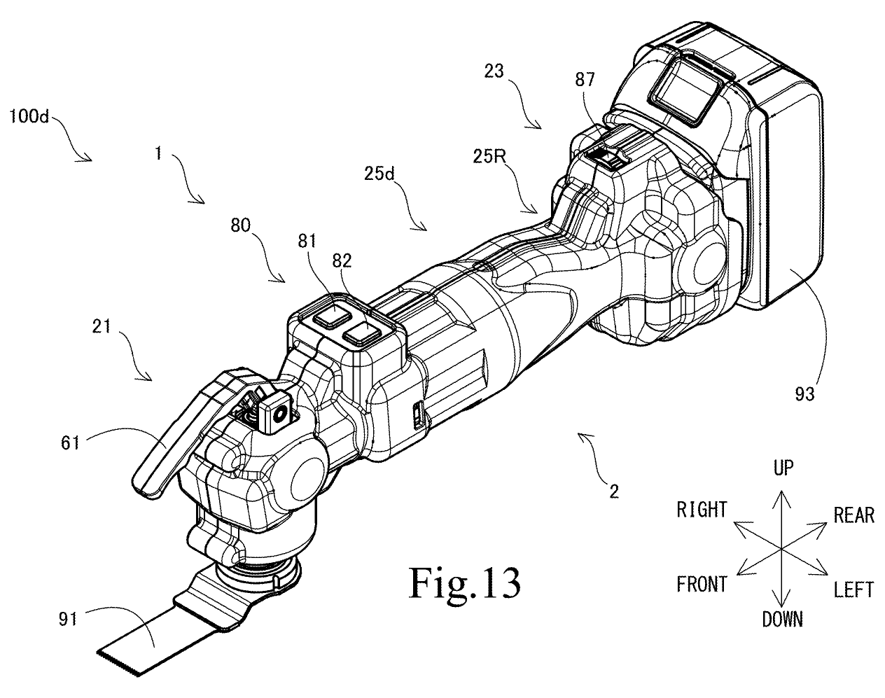

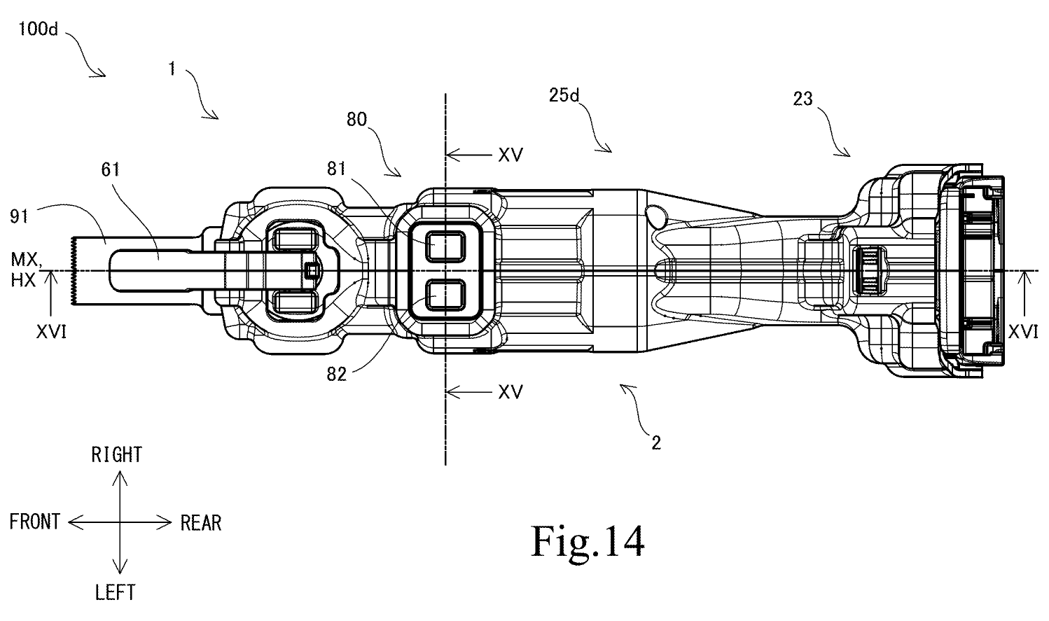

As shown in FIG. 13 and FIG. 14, an oscillating tool 100d according to a fourth embodiment differs from the oscillating tool 100 according to the first embodiment in that the oscillating tool 100d includes a switch unit 80 instead of the switch knob 290 and the switch 29, and includes a grip portion 25d instead of the grip portion 25. Other configurations are the same.

As shown in FIG. 13, the grip portion 25d differs from the grip portion 25 shown in the first embodiment in that the grip portion 25d includes a grip recess 25R. The grip recess 25R is a section at which the diameter is reduced compared to other sections of the grip portion 25d.

### D1. Configuration of switch unit 80

The switch unit 80 includes at least one press button type switch. In the example in FIG. 14, the switch unit 80 includes two press button type switches that include a first button 81 and a second button 82. The press button type switch refers to a device that is switched on and off by a pressing operation of a button type operation portion by the user, and thus switches on and off components included in the oscillating tool 100, such as the motor 53. The press button type switch includes a tactile switch, a push momentary switch, a rocker switch (also sometimes referred to as a seesaw switch), a membrane switch, and the like. Operation portions such as the above-described switch knob 290, paddle switch 290b, and trigger switch 290c are not included in the button type operation portion. In the present embodiment, the description is made using tactile switches as an example.

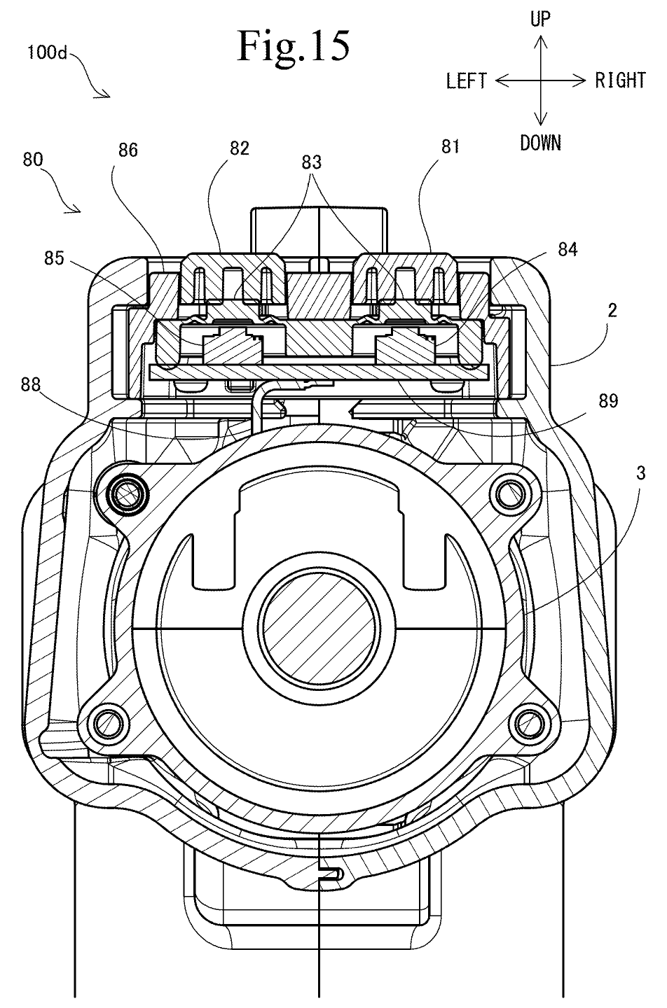

As shown in FIG. 15, the switch unit 80 includes the first button 81, the second button 82, pressing portions 83, a first switch 84, a second switch 85, the lead wire 88, and a circuit board 89. These members are housed in a switch housing 86.

The first switch 84 and the second switch 85 are mounted on the circuit board 89. Note that the first switch 84 and the second switch 85 are momentary switches, for example, and are only switched on during a period in which the first switch 84 and the second switch 85 are depressed. The circuit board 89 is electrically connected to the controller 4 via the lead wire 88.

The first button 81 and the second button 82 are exposed to the outside from the switch housing 86, and are configured to be able to be pressed down toward the inner housing 3 from the outside of the oscillating tool 100d. In the present embodiment, the first button 81 and the second button 82 are provided adjacent to each other in the left-right direction.

The pressing portions 83 are resin plungers. When the first button 81 is depressed, the pressing portion 83 inside the switch housing 86 is pressed down, and the first switch 84 is pressed in. As a result of the first switch 84 being pressed in, a signal for executing a function allocated to the first switch 84 is output to the controller 4 via the circuit board 89 and the lead wire 88.

In a similar manner, when the second button 82 is depressed, the pressing portion 83 inside the switch housing 86 is pressed down, and the second switch 85 is pressed in. As a result of the second switch 85 being pressed in, a signal for executing a function allocated to the second switch 85 is output to the controller 4 via the circuit board 89 and the lead wire 88.

Switching on and off desired functions that can be realized by the oscillating tool 100d can be allocated to the first switch 84 and the second switch 85. In the present embodiment, a function of switching the motor 53 on and off (driving and stopping the motor 53) is allocated to the first switch 84. A function of switching on and off an illumination device (not shown in the drawings) provided in the oscillating tool 100d (illuminating and extinguishing illumination) is allocated to the second switch 85, for example. However, the configuration is not limited to this example, and a function of a safety device may be allocated, for example, in which the activation of the oscillating tool 100d is allowed when the first switch 84 and the second switch 85 are simultaneously depressed. Further, when one of the switches that can switch the motor 53 on and off fails, the other switch may compensate for the function of the one switch. In this case, for example, the other switch may be allocated the function of switching the motor 53 on and off in a backup manner. According to the oscillating tool 100d according to the present embodiment, by providing the plurality of switches in this way, the user can easily cause the oscillating tool 100d to execute a plurality of functions.

### D2. Arrangement configuration of switch unit 80

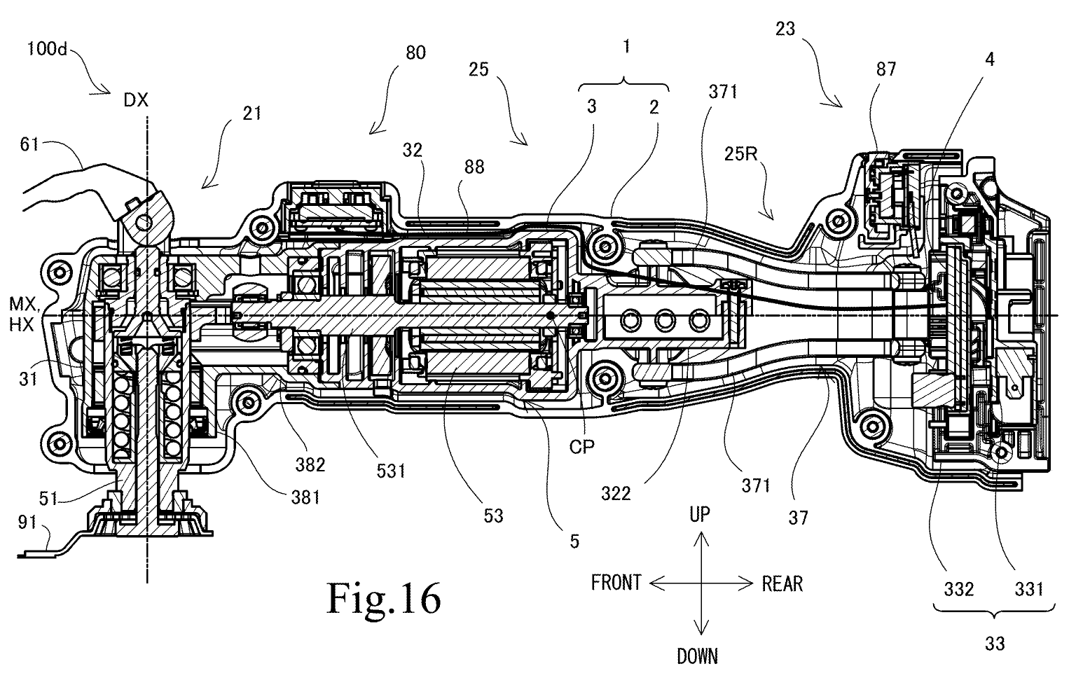

As shown in FIG. 16, in the oscillating tool 100d according to the present embodiment, the switch unit 80 is disposed so as to have the following characteristics.

(1) The plurality of press button type switches, namely, the first button 81, the second button 82, the first switch 84, and the second switch 85 are gathered in one location as the switch unit 80. Thus, compared to a case in which the plurality of press button type switches are disposed in a plurality of locations, a number of components inside the housing 1 can be reduced, and the housing 1 can be downsized.

Further, in the oscillating tool 100d according to the present embodiment, by using the press button type switches, for example, the switches and the operation portions are concentrated at the one locations, and compared to a case in which the operation portions are provided at a plurality of locations, a region in which the operation portions and the switches are disposed can be made smaller. Further, in the press button type switch, a switch lever is not necessary. Thus, compared to an operation portion that uses a switch knob, it is possible to eliminate components such as the switch lever, and the number of components inside the grip portion 25d can be reduced. As a result, part of the grip portion 25d can be made narrower and the grip recess 25R can be formed, and the portability of the oscillating tool 100d can thus be improved.

(2) The switch unit 80 is disposed further upward than the rotation axis MX of the motor 53 (than a center axis HX of the inner housing 3). Thus, the user can easily see the first button 81 and the second button 82 from above, and can easily operate the first button 81 and the second button 82.

(3) As shown in FIG. 16, the switch unit 80 is disposed further to the front than the center point CP of the inner housing 3 in the front-rear direction. By being configured in this way, the user can easily see the switch unit 80 while holding the grip portion 25d, and can easily operate the first button 81 and the second button 82.

(4) The switch unit 80 is disposed to the outer side of the motor housing 32, in the radial direction centering on the rotation axis MX. Compared to a case in which the switch unit 80 is disposed on the outer side of a member further to the rear than the motor housing 32, the grip portion 25d can be formed over a wide range in the front-rear direction, and the portability of the oscillating tool 100d can be improved.

(5) The switch unit 80 is disposed further to the rear than the front housing 31. Compared to a case in which the switch unit 80 is disposed in the front housing 31, the first button 81 and the second button 82 can be disposed at positions separated from the workpiece and the tip tool 91. Thus, operability of the first button 81 and the second button 82 can be improved. However, the switch unit 80 can be disposed to the outer side of the front housing 31. In this case, the grip portion 25d can be formed over an even wider range in the front-rear direction.

(6) As shown in FIG. 16, the lead wire 88 is disposed between the inner housing 3 and the outer housing 2. More specifically, the lead wire 88 pulled out from the switch unit 80 is disposed in a space between the outer surface of the motor housing 32 and the inner surface of the grip portion 25d, in the inner housing 3. The lead wire 88 is disposed in a space formed between the plurality of elastic members 371 and is electrically connected to the controller 4. The lead wire 88 can be efficiently disposed by utilizing the spaces formed by the anti-vibration housing having the two-layer structure. Note that although not shown in the drawings, a power line for inputting the signal to the motor 53 for driving the motor 53 is electrically connected to the motor 53 from the controller 4 via the extending portion 322.

As described above, the oscillating tool 100d according to the present embodiment includes the anti-vibration housing having the two-layer structure including the inner housing 3 and the outer housing 2 that houses the inner housing 3. Further, the oscillating tool 100d includes the press button type switch that switches the motor 53 on and off in accordance with the manual operation by the user. By using the press button type switches as the operation portions that switch the motor 53 on and off, compared to a configuration in which the operation portions are provided at the plurality of locations, the region in which the operation portions and the switches are disposed can be made smaller. Further, it is possible to omit components such as the switch lever, and compared to the operation portion that uses the switch knob, the number of components inside the housing 1 can be reduced. Thus, it is possible to provide the oscillating tool 100d having the high anti-vibration capability while suppressing an increase in size due to the configuration of the switches.

In the oscillating tool 100d, the lead wire 88 that electrically connects the switch unit 80 and the motor 53 is disposed between the inner housing 3 and the outer housing 2. The lead wire 88 can be efficiently disposed by utilizing the spaces formed by the anti-vibration housing having the two-layer structure.

A correspondence between each of structural elements (features) of the above-described embodiments and each of structural elements (features) of the present disclosure or the present invention is as described below. Note that each of the structural elements of the embodiment is merely an example, and is not intended to limit each of the structural elements of the present disclosure or the present invention.

The oscillating tools 100, 100b, 100c, and 100d are an example of a “power tool”. The drive axis DX is an example of a “drive axis”. The inner housing 3 and the outer housing 2 are an example of an “inner housing” and an “outer housing”. The rotation axis MX and the center axis HX are an example of an “inner housing center axis”. The switch unit 80, the first button 81 and the first switch 84, and the second button 82 and the second switch 85 are an example of a “press button type switch”. The motor housing 32 and the front housing 31 are an example of a “motor housing” and a “front housing”. The lead wire 88 is an example of a “lead wire”. The first switch 84 and the second switch 85 are an example of a “first switch” and a “second switch”. The rotation axis MX is an example of a “motor rotation axis”. The output shaft 531 is an example of a “motor shaft”. The switch knob 290, the paddle switch 290b, the trigger switch 290c, the first button 81, and the second button 82 are an example of an “operation portion”. The switch unit 80 is an example of a “switch unit”. The switch 29, the switch 29b, the switch 29c, the first switch 84, and the second switch 85 are an example of a “switch”.

Note that the power tool according to the present disclosure is not limited to the oscillating tools 100, 100b, 100c, and 100d according to the above-described embodiments. For example, changes exemplified below in a non-limiting manner are possible. Further, at least one of those changes can be adopted in combination with at least one of the oscillating tools 100, 100b, 100c, and 100d according to the embodiments, and the features described in the claims.

(E1) In each of the above-described embodiments, the example is shown in which the motor 53 is arranged such that the rotation axis MX of the output shaft 531 of the motor 53 is orthogonal to the drive axis DX of the spindle 51. In contrast, the motor 53 may be arranged such that the rotation axis MX and the drive axis DX are parallel to each other. When the configuration is adopted in which the rotation axis MX and the drive axis DX are parallel to each other, the front-rear direction of the oscillating tool 100 can be defined by the extending direction of the inner housing 3 (the direction corresponding to a long axis of the inner housing 3), instead of the rotation axis MX of the output shaft 531 of the motor 53. The extending direction of the inner housing 3 and the long axis of the inner housing 3 can be defined using the center axis of the inner housing 3 or the center axis of the grip portion 25.

(E2) In the above-described fourth embodiment, the example is shown in which the oscillating tool 100d includes the switch unit 80, and the lead wire 88 is disposed between the outer housing 2 and the inner housing 3. In contrast, the oscillating tool 100d may include an operation portion and switch configured differently from the press button type switch. In this case, a lead wire pulled out from the switch is disposed between the outer housing 2 and the inner housing 3. Even with this configuration, by utilizing a space formed by the anti-vibration housing having the two-layer structure, the lead wire can be efficiently disposed.

Furthermore, in view of the present invention and the gist of the above-described embodiments, the following aspects are constructed. At least one of the following aspects can be adopted in combination with the above-described embodiments and modified examples thereof, or with at least one of the features disclosed in each of claims.

### Aspect 1

The inner housing includes

a motor housing housing the motor,

a front housing connected to a front end of the motor housing, and housing the spindle,

a rear housing including a battery attachment portion to which a battery is attachable, and

an elastic coupling portion extending in the front-rear direction, and elastically coupling a rear end of the motor housing and a front end of the rear housing to each other.

The elastic coupling portion 37 and the elastic members 371 according to the above-described embodiments are an example of an “elastic coupling portion”.

### ASPECT 2

The power tool further includes (i) a front elastic member elastically coupling the front housing to the outer housing, and (ii) a rear elastic member elastically coupling the rear housing and the outer housing.

The front elastic member 71 according to the above-described embodiments is an example of the “front elastic member”, and the rear elastic member 76 is an example of the “rear elastic member”.

### ASPECT 3

The press button type switch or the switch unit are provided at a single location of the outer housing.

The present disclosure is not limited to the above-described embodiments, and can be realized by various configurations insofar as they do not depart from the gist and scope of the present disclosure. For example, technological features in the embodiments corresponding to technological features in each of modes listed in the Summary of the invention can be switched or combined as appropriate, in order to resolve some or all of the above-described problems, or in order to achieve some or all of the above-described effects. Further, those technological features can be omitted as appropriate insofar as they are not described as being essential in the present specification.

### DESCRIPTION OF REFERENCE NUMERALS

1 Housing, 2 Outer housing, 3 Inner housing, 4 Controller, 5 Drive mechanism, 6 Lock mechanism, 21 Front end portion, 23 Rear end portion, 25, 25d Grip portion, 25R Grip recess, 29, 29b, 29c Switch, 31 Front housing, 32 Motor housing, 32L Contour, 33 Rear housing, 37 Elastic coupling portion, 37D Reducing diameter portion, 37F Front end portion, 37R Rear end portion, 38 Metal housing, 39 Resin housing, 51 Spindle, 52 Clamp shaft, 53 Motor, 55 Transmission mechanism, 61 Operation lever, 63 Compression coil spring, 65 Collar, 67 Clamp member, 71 Front elastic member, 72 Coupling member, 76 Rear elastic member, 80 Switch unit, 81 First button, 82 Second button, 83 Pressing portion, 84 First switch, 85 Second switch, 86 Switch housing, 87 Dial, 88 Lead wire, 89 Circuit board, 91 Tip tool, 93 Battery, 100, 100b, 100c, 100d Oscillating tool, 290 Switch knob, 290b Paddle switch, 290c Trigger switch, 291 Switch lever, 294 Coil spring, 295 Plunger, 296 Pressing portion, 298 Lock-off lever, 321 Circular cylindrical portion, 322 Extending portion, 331 Battery attachment portion, 332 Controller housing portion, 332F Front surface, 333 Protruding portion, 334 Screw, 352 Protrusion, 354 Screw, 371 Elastic member, 381 First section, 382 Second section, 383 Recess, 511 Tool attachment portion, 512, 513 Bearing, 521 Clamp head, 523 Groove portion, 531 Output shaft, 532 Stator, 533 Rotor, 551 Eccentric shaft, 552 Arm portion, 553 Coupling arm, 554 Annular portion, 555 Drive bearing, 652 Spring, 671 Convex portion, 710 Through hole, CP Center point, DX Drive axis, HX Center axis, LA Total length, LD Large diameter portion, LM1 First largest distance, LM2 Second largest distance, LS Shortest distance, MD Minimum diameter portion, MX Rotation axis, SD Small diameter portion

1. A power tool comprising:
a motor;
a spindle configured to use power from the motor to drive a tip tool to oscillate around a drive axis defining an up-down direction of the power tool;
an inner housing housing the motor, the inner housing extending in a front-rear direction of the power tool orthogonal to the drive axis;
an outer housing housing the inner housing; and
at least one press button type switch configured to switch the motor on and off in accordance with a manual operation by a user.

2. The power tool according to claim 1, wherein
when one end portion of the spindle to which the tip tool is attached is defined as a lower side of the power tool in the up-down direction, and the other side is defined as an upper side,
the at least one press button type switch is disposed further to the upper side than a center axis of the inner housing.

3. The power tool according to claim 1, wherein
when one end portion of the inner housing in which the spindle is housed is defined as a front side in the front-rear direction, and the opposite side is defined as a rear side,
the at least one press button type switch is disposed further to the front side than a center point of the inner housing in the front-rear direction.

4. The power tool according to claim 1, wherein
the inner housing includes
a motor housing housing the motor, and
a front housing connected to a front end of the motor housing, and housing the spindle, and
the at least one press button type switch is disposed at at least one of an outer side of the motor housing or an outer side of the front housing, in a radial direction centering on a center axis of the inner housing.

5. The power tool according to claim 4, wherein
when one end portion of the inner housing in which the spindle is housed is defined as a front side in the front-rear direction, and the opposite side is defined as a rear side,
the at least one press button type switch is disposed further to the rear side than the front housing.

6. The power tool according to claim 1, further comprising:
a lead wire electrically connecting the at least one press button type switch to a controller configured to control driving of the motor, wherein
the lead wire is disposed between the inner housing and the outer housing.

7. The power tool according to claim 1, wherein
the at least one press button type switch includes a first switch and a second switch different from the first switch.

8. The power tool according to claim 1, wherein
the motor includes a motor shaft configured to rotate around a motor rotation axis, and
the motor rotation axis is orthogonal to the drive axis.

9. The power tool according to claim 1, wherein
the inner housing includes
a motor housing housing the motor,
a front housing connected to a front end of the motor housing, and housing the spindle,
a rear housing including a battery attachment portion to which a battery is attachable, and
an elastic coupling portion extending in the front-rear direction, and elastically coupling a rear end of the motor housing and a front end of the rear housing to each other.

10. The power tool according to claim 9, further comprising:
(i) a front elastic member elastically coupling the front housing and the outer housing; and
(ii) a rear elastic member elastically coupling the rear housing and the outer housing.

11. The power tool according to claim 1, wherein
the press button type switch is provided at one location of the outer housing.

12. A power tool comprising:
a motor;
a spindle configured to use power from the motor to drive a tip tool to oscillate around a drive axis defining an up-down direction of the power tool;
an inner housing housing the motor, the inner housing extending in a front-rear direction of the power tool orthogonal to the drive axis;
an outer housing housing at least a part of the inner housing;
an operation portion configured to be operable by a user;
a switch configured to switch the motor on and off in accordance with an operation of the operation portion; and
a lead wire electrically connecting the switch and a controller configured to control driving of the motor, wherein
the lead wire is disposed between the inner housing and the outer housing.

13. The power tool according to claim 12, further comprising:
a switch unit including the operation portion and the switch.

14. The power tool according to claim 13, wherein
when one end portion of the spindle to which the tip tool is attached is defined as a lower side of the power tool in the up-down direction, and the other side is defined as an upper side,
the switch unit is disposed further to the upper side than a center axis of the inner housing.

15. The power tool according to claim 13, wherein
when one end portion of the inner housing in which the spindle is housed is defined as a front side in the front-rear direction, and the opposite side is defined as a rear side,
the switch unit is disposed further to the front side than a center point of the inner housing in the front-rear direction.

16. The power tool according to claim 13, wherein
the inner housing includes
a motor housing housing the motor, and
a front housing connected to a front end of the motor housing, and housing the spindle, and
the switch unit is disposed at at least one of an outer side of the motor housing or an outer side of the front housing, in a radial direction centering on a center axis of the inner housing.

17. The power tool according to claim 16, wherein
when one end portion of the inner housing in which the spindle is housed is defined as a front side in the front-rear direction, and the opposite side is defined as a rear side,
the switch unit is disposed further to the rear side than the front housing.

18. The power tool according to claim 13, wherein
the switch unit includes a first switch, and a second switch different from the first switch.

19. The power tool according to claim 12, wherein
the motor includes a motor shaft configured to rotate around a motor rotation axis, and
the motor rotation axis is orthogonal to the drive axis.

20. The power tool according to claim 13, wherein
the switch unit is provided at one location of the outer housing.
